(19) United States
(12) Patent Application Publication
(10) Pub. No.: US 2013/0264296 A1
(43) Pub. Date: Oct. 10, 2013

(54) FILTERING APPARATUS FOR REMOVING SOLID MATERIAL FROM A FLUID IN A CHANNEL

(71) Applicant: Parkson Corporation, Fort Lauderdale, FL (US)

(72) Inventors: Alejandro Mejia, Coral Springs, FL (US); Jesus Rodriquez, Lincolnwood, IL (US); David Mitchell, Wilmette, IL (US)

(21) Appl. No.: 13/801,119

(22) Filed: Mar. 13, 2013

Related U.S. Application Data
(60) Provisional application No. 61/612,103, filed on Mar. 16, 2012.

(51) Int. Cl. B01D 33/46

(52) U.S. Cl. CPC B01D 33/461
USPC 210/791; 210/391; 15/4

(57) ABSTRACT

A filtering apparatus removes solid material from a fluid in a channel. The filtering apparatus comprises a housing that comprises a substantially vertical passage, a substantially horizontal passage connected to the vertical passage, and an outlet connected to the substantially horizontal passage; a filter medium comprising a plurality of transverse rods and a plurality of filter plates rotatably disposed along each of the transverse rods; a guide track system configured to guide the endless belt from the channel to the outlet; and a drive mechanism configured to convey the filter medium around the closed loop. The guide track system comprises two or more release points where the bearing portions of the filter plates can rotate about the transverse rods so as to permit dislodgement of the solid material from the filter plates. The two release points are located in a portion of the closed loop in the substantially horizontal passage.

### CROSS-REFERENCE TO RELATED PATENT APPLICATIONS

This application claims the benefit of the priority date of U.S. Provisional Application Ser. No. 61/612,103, filed Mar. 16, 2012, the content of which is incorporated herein by reference in its entirety.

### BACKGROUND

The present invention relates to a filtering apparatus for removing solid material from a fluid in a channel, a cleaning device for removing solid material from a filter medium, and a method of inhibiting an unwanted accumulation of waste material captured in an endless belt comprising filtering elements.

Filter media in the form of endless belts of plate elements are used to remove waste materials and other impurities from wastewater. However, these filter media are subject to clogging by the waste material that accumulates in the filter media. The present invention relates to improving the efficiency of the filter media by removing waste material that accumulates in the filter media.

### SUMMARY

According to one embodiment of the present invention, a filtering apparatus for removing solid material from a fluid in a channel may comprise a housing that extends upward from the channel and comprises a substantially vertical passage, a substantially horizontal passage connected to the vertical passage, and an outlet connected to the substantially horizontal passage; a filter medium comprising a plurality of transverse rods and a plurality of filter plates rotatably disposed along each of the transverse rods, in which adjacent transverse rods are connected to each other such that the filter plates form an endless belt in a closed loop, in which each of the filter plates comprises a bearing portion configured to remove the solid material from the channel; a guide track system configured to guide the endless belt from the channel to the outlet; and a drive mechanism configured to convey the filter medium around the closed loop. The guide track system may comprise two or more release points where the bearing portions of the filter plates can rotate about the transverse rods so as to permit dislodgement of the solid material from the filter plates. The two release points are located in a portion of the closed loop in the substantially horizontal passage.

According to another embodiment of the present invention, a filtering apparatus for removing solid material from a fluid in a channel, may comprise a housing that extends from the channel and comprises a passage, and an outlet connected to the passage; a filter medium comprising an endless belt in a closed loop configured to remove the solid material from the channel; a guide track system configured to guide the endless belt from the channel to the outlet; a drive mechanism configured convey the filter medium around the closed loop; and a rotatable brush configured to remove the solid material from the filter medium. The brush comprises a central body and a mixture of bristles and wipers interspersed around the central body.

According to another embodiment of the present invention, a cleaning device for removing solid material from a filter medium may comprise a central body; a plurality of rows of bristles disposed around the central body; and a plurality of wipers interspersed between the rows of the bristles and disposed around the central body.

According to another embodiment of the present invention, a method of inhibiting an unwanted accumulation of waste material captured in an endless belt comprising filtering elements, may comprise: turning the endless belt about an axis to allow a portion of the waste material to separate from the endless belt; and causing rotation of the filter elements at two or more release points after the rotation about the axis to allow dislodgement of a portion of any remaining waste material from the endless belt.

It is to be understood that both the foregoing general description and the following detailed descriptions are exemplary and explanatory only, and are not restrictive of the invention as claimed.

### BRIEF DESCRIPTION OF THE DRAWINGS

The features, aspects, and advantages of the present invention will become apparent from the description, appended claims, and the accompanying exemplary embodiments shown in the drawings, which are briefly described below.

FIG. 1 shows a filtering apparatus according to an embodiment of the present invention.

FIG. 2 shows the components inside the housing of the filtering apparatus of FIG. 1.

FIG. 3 shows the filtering apparatus of FIG. 1 with the filtering medium exposed.

FIG. 4 shows a traverse rod and a row of filter plates or elements of the filter medium according to one embodiment of the present invention.

FIG. 5 shows a plurality of transverse rods connected to each other using the filter plates according to one embodiment of the present invention.

FIG. 6 shows a single filter plate or element according to one embodiment of the present invention.

FIG. 7 shows a detailed view of the upper portion of the components inside the housing of the filtering apparatus of FIG. 2.

FIG. 8 shows a cleaning device according to an embodiment of the present invention.

FIG. 9 shows a wiper for the cleaning device according to one embodiment of the present invention.

FIG. 10 shows a wiper for the cleaning device according to another embodiment of the present invention.

FIG. 11 shows a control unit for the filtering apparatus of FIG. 1 according to one embodiment of the present invention.

FIG. 12 shows an alternative placement of the cleaning devices in the filtering apparatus according to an embodiment of the present invention.

FIG. 13 shows an alternative view of the cleaning device of FIG. 8.

FIGS. 14a and 14b show the status of the cleaning device after 1.5 days of use in the filtering apparatus according to one embodiment of the present invention.

FIGS. 14c and 14d show the status of the cleaning device after several weeks in operation in the filtering apparatus according to the embodiment of FIGS. 14a and 14b.

FIG. 15 shows a table indicating the results of a series of runs which provides a side-by-side comparison of a conventional device with that of the filtering apparatus according to an embodiment of the present invention.

FIG. 16 shows a depiction of how solids material is matted on the filter elements.

FIGS. 17a, 17b, and 17c show a cleaning device according to an embodiment of the present invention.

FIG. 18 shows a single filter plate or element according to another embodiment of the present invention.

FIG. 19 shows a filter medium comprising a plurality of filter plates like those shown in FIG. 18.

### DETAILED DESCRIPTION OF THE PREFERRED EMBODIMENTS

Various embodiments of the present invention will be explained with reference to the accompanying drawings.

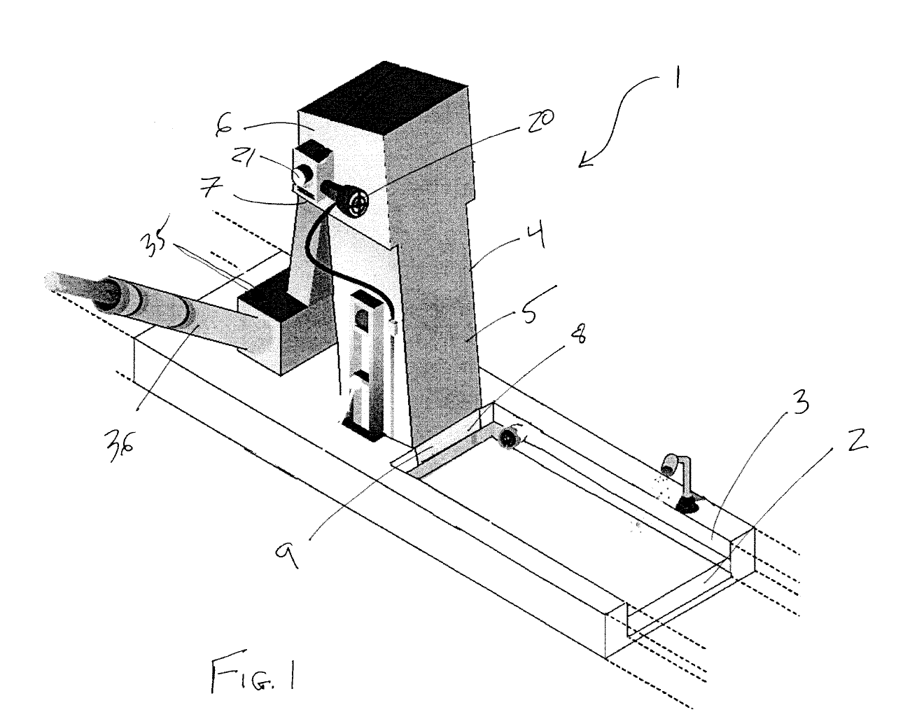

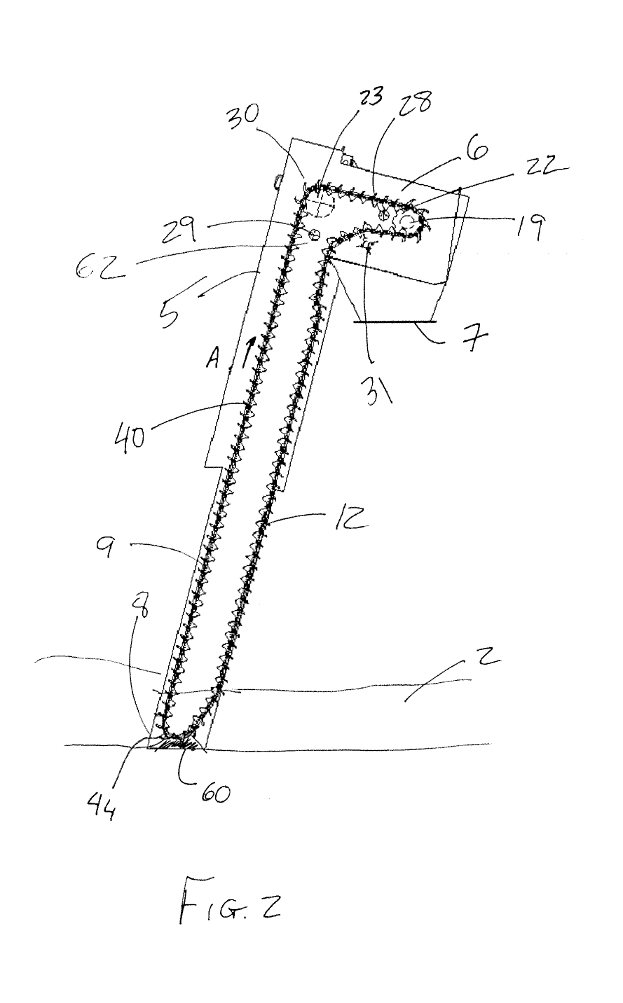

FIGS. 1 and 2 show a filtering apparatus 1 for removing solid material from a fluid 2 in a channel 3 according to an embodiment of the present invention. The fluid that can be cleaned includes, for example, wastewater or other liquids.

The filtering apparatus comprises a housing 4 that extends upward from the channel 3 and comprises a substantially vertical passage 5, a substantially horizontal passage 6 connected to the vertical passage 5, and an outlet 7 connected to the substantially horizontal passage. For example, the substantially horizontal passage 6 can be a passage whose centerline axis is within a range of 0-45 degrees, preferably within a range of 0-40 degrees, most preferably within a range of 0-20 degrees, of a horizontal line which insects the centerline axis of the substantially horizontal passage. The substantially vertical passage can be a passage whose centerline axis is within a range of 0-45 degrees, preferably within a range of 10-35 degrees, most preferably within a range of 10-30 degrees, of a vertical line which intersects the centerline axis of the substantially vertical passage. According to one embodiment, for example, the substantially horizontal passage 6 can be 15 degrees from the horizontal line which insects the centerline axis of the substantially horizontal passage and the substantially vertical passage can be 75 degrees from the vertical line which intersects the centerline axis of the substantially vertical passage.

The housing includes an inlet 8 in fluid communication with the channel 3 for the fluid with solid waste material to enter therethrough and an outlet 7. The outlet 7 may be a disposal chute or other form of outlet placed at the end of the substantially horizontal passage 6.

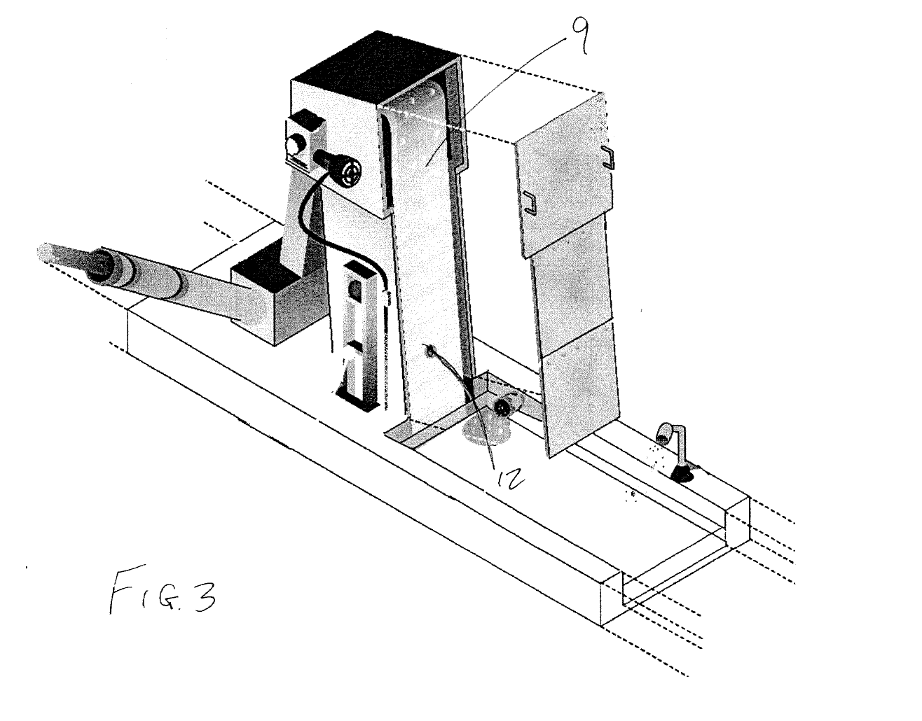

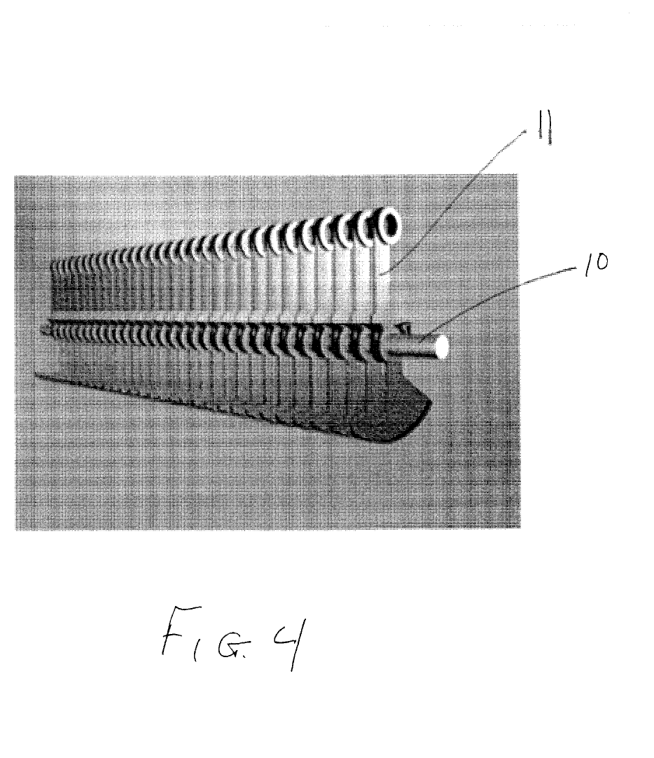

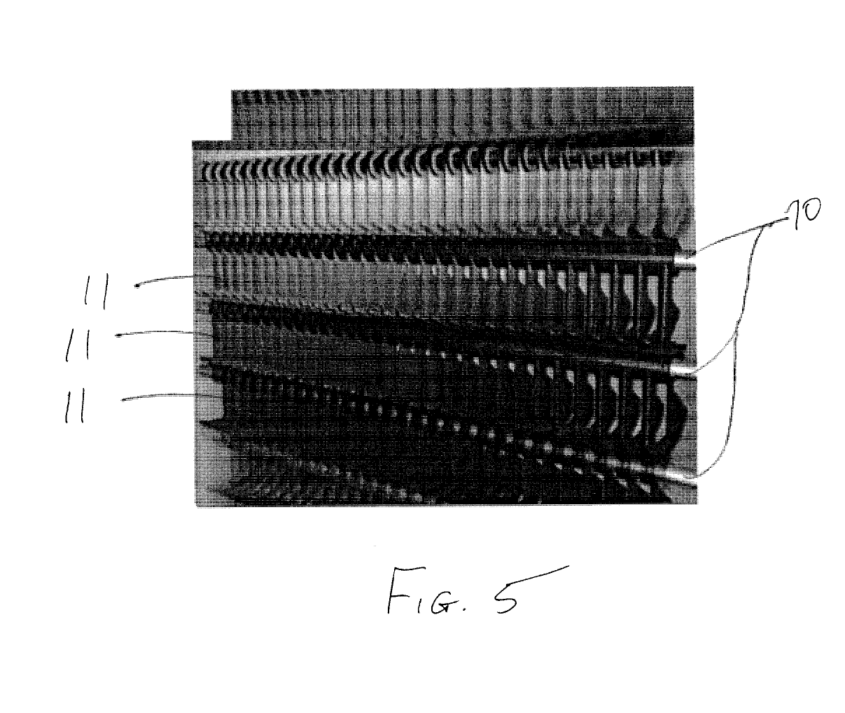

Within the housing 4, a filter medium 9 is disposed as seen in FIGS. 2 and 3. The filter medium comprises a plurality of transverse rods 10 and a plurality of filter plates or elements 11 rotatably disposed along each of the transverse rods 10. FIG. 4 shows one traverse rod 10 and a row of filter plates or elements 11 of the filter medium 9. FIG. 5 shows how the plurality of transverse rods 10 are connected to each other by using the filter plates 11. FIG. 6 shows a single filter plate or element 11. Additionally, there may be a chain attached to the ends (and sometimes middle) of the transverse rods 11. The chain supports the weight of the moving belt and it conveys the elements and transverse rods around the track in the closed loop.

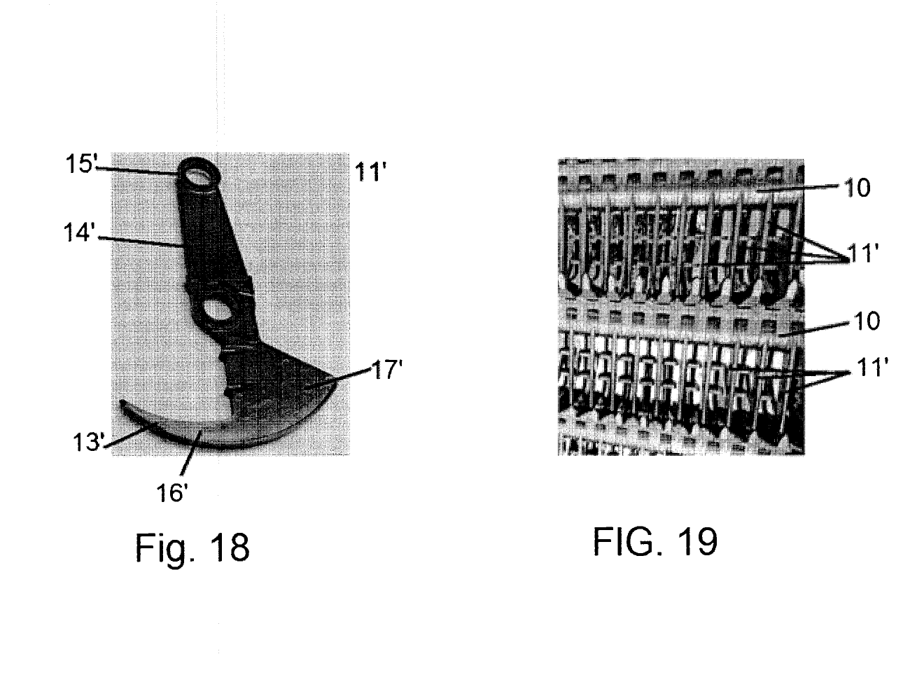

FIG. 6 shows that each of the filter plates 11 comprises a bearing portion 13 configured to remove the solid waste material from the channel 3, a shaft portion 14, and two holes 15 through which two transverse rods 10 can be inserted thereto. The bearing portion 13 includes a hook portion 16 and a back portion 17. The hook portion 16 is used to capture, lift, or convey the solid waste material from the fluid 2 in the channel 3. The filter plates as described in FIGS. 4-6 are merely exemplary and any suitable shape of filter plate may be used to form the endless belt 12, for example the filter elements disclosed in U.S. Pat. Nos. 3,856,678 and 4,323,451, which are incorporated by reference in their entireties, can be used. FIG. 18 shows another filter plate 11′ comprises a bearing portion 13′ configured to remove the solid waste material from the channel 3, a shaft portion 14′, and two holes 15′ through which two transverse rods 10 can be inserted thereto. The bearing portion 13′ includes a hook portion 16′ and a back portion 17′. The hook portion 16′ is used to capture, lift, or convey the solid waste material from the fluid 2 in the channel 3.

FIG. 5 shows that adjacent transverse rods 10 are connected to each other by stitching alternating filter plates together using the filter plates 11 in which the adjacent transverse rods 10 are fed into the holes 15 of the filter plates 11 such that the filter plates 11 form an endless belt 12 in a closed loop 40. The rows of filter plates 11 on each transverse rod 10 alternate between the filter plates in which the rod 10 goes through the lower holes 15 (near the bearing portion 13) and the filter plates in which the transverse rod 10 goes though the upper holes 15. Any suitable number of filter plates may be placed on the transverse rods, such as 10, 20, 30, 50, or any integer therebetween. The filter plates 11 may be made of any suitable material, such as (but not limited to) steel, hard plastic (such as PVC), stainless steel, or any other suitable metal or plastic, or fiberglass. Similarly, the transverse rods may be any suitable material, such as, for example (but not limited to), steel, stainless steel, or hard plastic. FIG. 19 is similar to that shown in FIG. 5 but that it shows a filter medium comprising a plurality of filter plates 11′ like those shown in FIG. 18

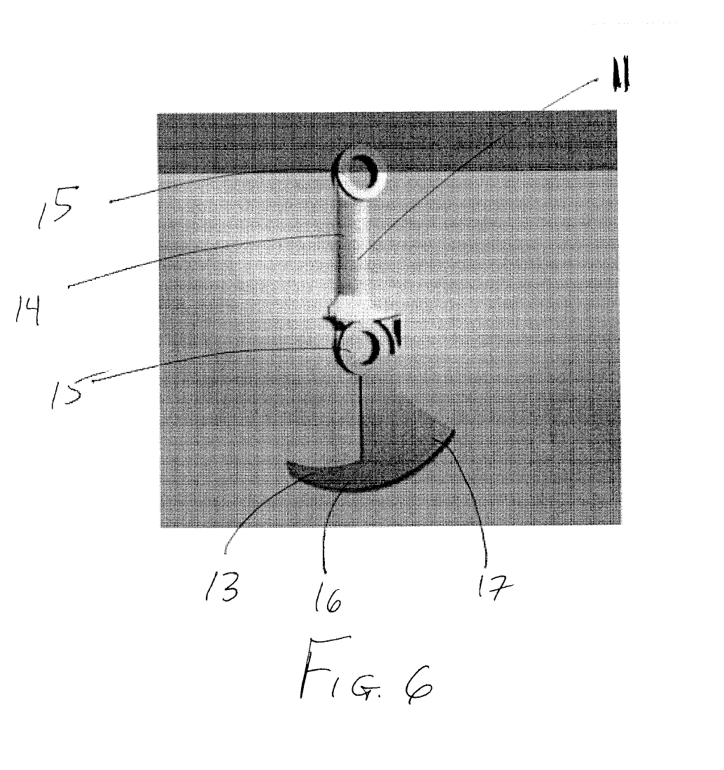

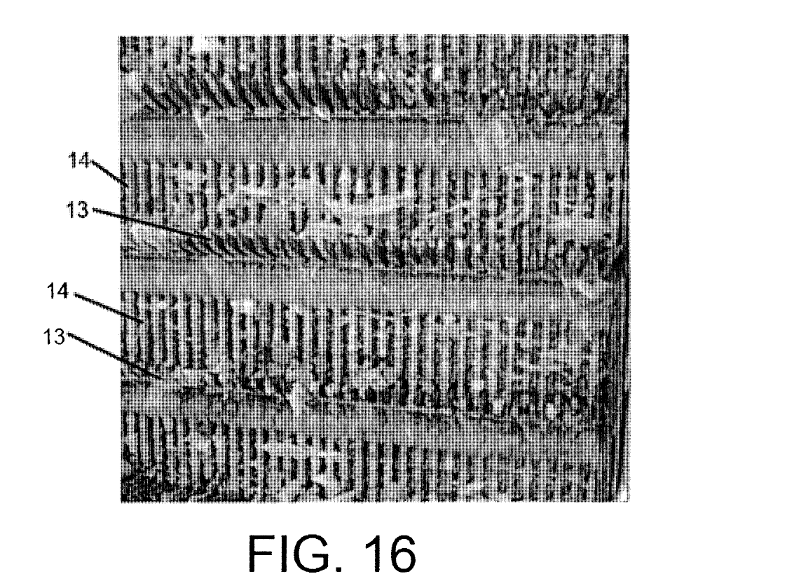

As seen in FIGS. 2 and 7, a drive mechanism 21 is configured to convey the filter medium 9 around the closed loop 40. When it does so, as seen in FIG. 16, solid material can be matted on the filter plates or elements. The solids may collect on the shaft portion 14 of the element 11, but also on the lower section between the hole 15 and the bearing portion 13.

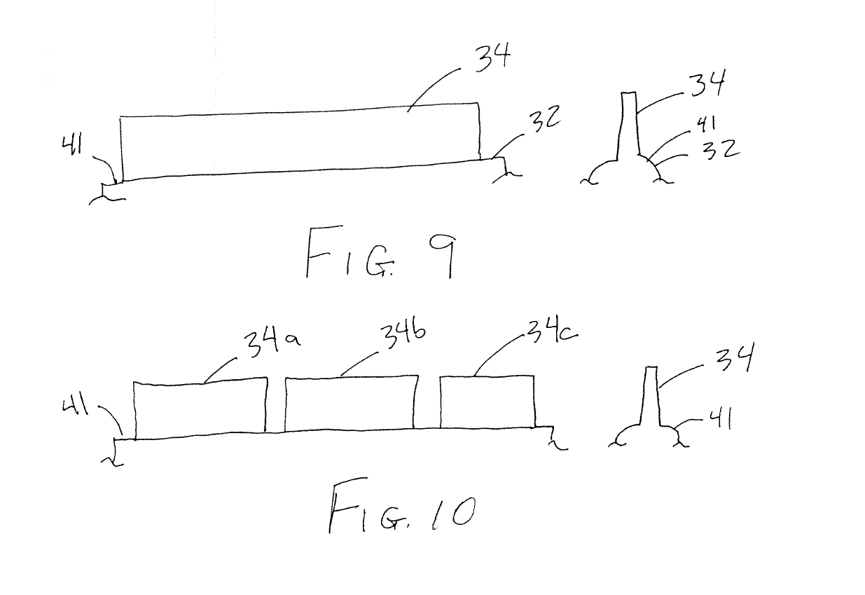

The drive mechanism may include a motor 20 connected to a shaft 19 that rotates a drive wheel 22. The drive wheel 22 may engage the endless belt 12 so as to move the endless belt 12 in a conveyor belt-like fashion. As seen in FIG. 11, the drive mechanism may be controlled by a control unit 100 that contains all the necessary hardware and/or software to operate the drive mechanism 21 and the filtering apparatus 1 in general.

The endless belt 12 runs along a guide track system 18 configured to guide the endless belt 12 from the channel 3 to the outlet 7. The guide track system may be configured to form the endless belt 12 into an upside down L-shape, as seen in FIG. 2. The guide track system 18 may comprises one or more guide wheels or sprockets 23 mounted to the housing 4 using brackets 45, an end rail 44 near a seal 60 (in FIG. 2) at the channel 3, and two or more release points 24 and 25 where the bearing portions 13 of the filter plates 11 can rotate about their transverse rods 10 so as to permit dislodgement of the solid material from the filter plates 11 after they have passed the drive wheel 22 where the solid material typically falls into the outlet 7. The two release points 24 and 25 are located in a portion of the closed loop in the substantially horizontal passage 6. The two release points 24 and 25 may be formed by arched pathways 27 and 26, respectively, positioned below the endless belt 12 in the portion of the closed loop 40 in the substantially horizontal passage 6. The arched pathways may be one or more guide rails running parallel to the transverse rods 10 so as to cause the endless belt 12 to bend concavely inward. With the closed loop 40 of the endless belt 12 having two release points, one row of filter plates or elements 11 may retract thru the endless belt 12. This retracting action permits dislodgement of solid waste material to drop of the endless belt. Although FIG. 7 shows the arched pathways 27 ad 26 are two different guide rails, these pathways may be made from one single guide rails or more than 2 guide rails.

The release points 24 and 25 may be placed in any suitable location. For example, at least one of the two release points 24 may be located in the intersection of the substantially horizontal passage 6 and the substantially vertical passage 5. The intersection being the portion of the housing 4 where the substantially vertical and substantially horizontal passages overlap. The other of the two release points 25 may located at a distance from the intersection 30 (in FIG. 2) of the substantially horizontal passage 6 and the substantially vertical passage 5. According to one embodiment of the present invention, the location of the release point 25 is positioned at least 4″, preferably approximately 12″, further away from the substantially vertical passage 5 to keep solid waste material from accumulating in the lower inside section 62 of the intersection 30 of the substantially vertical passage 5 and the substantially horizontal passage 6 or from falling into the substantially vertical passage 5. It is also contemplated that more than two release points may be used such as three, four, or more.

As seen in FIGS. 2 and 7, the filtering apparatus 1 may further comprise two cleaning devices 28 and 29 configured to spray cleaning fluid on the filter medium 9. The cleaning fluid acts to make the solid waste material heavier so the solid waste material will simply fall off the endless belt 12. According to one embodiment, the cleaning fluid may be water or some other suitable chemical solution. The two cleaning devices 28 and 29 may comprise spray bars connected to a fluid source 51 and delivery system 50 with the necessary valves, piping/hosing and the like such that the cleaning fluid can be delivered onto the endless belt 12 with a pressure in a range of about 5 to about 100 psi, preferably in a range of about 5 to about 10 psi. However, other pressures may be used as well. There can be an advantage in using a pressure between 5 and 10 psi in that, although it is effective in removing solids, the lower pressure reduces water consumption. The delivery system may be control using the control unit 100 as seen in FIG. 11 or a separate spray control unit. The spraying may be continuous or intermittently as controlled by the control unit. Alternatively, the delivery system may be a simple valve that turns on and off so as to deliver the fluid from the fluid source 51 to the cleaning devices 28 and 29.

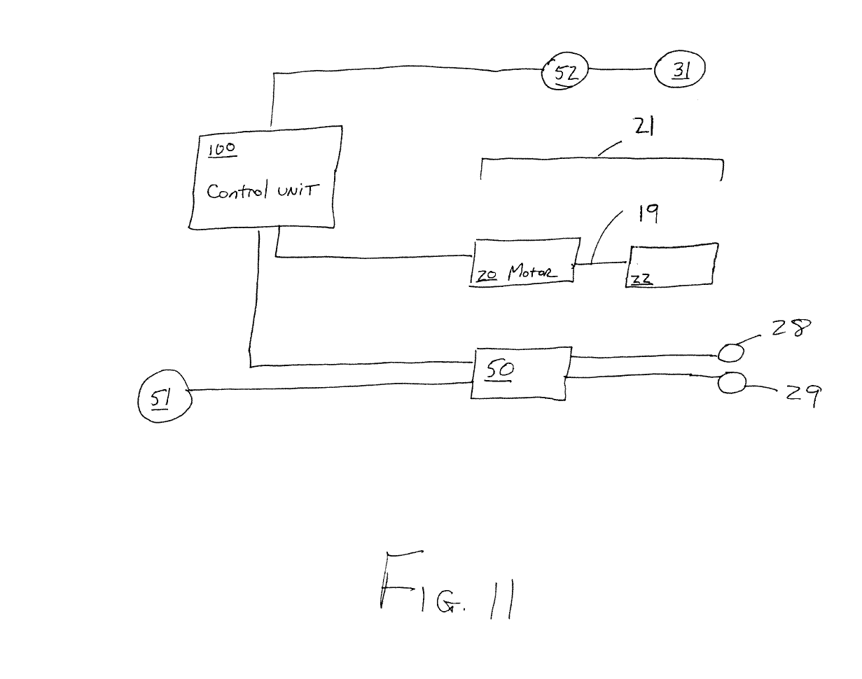

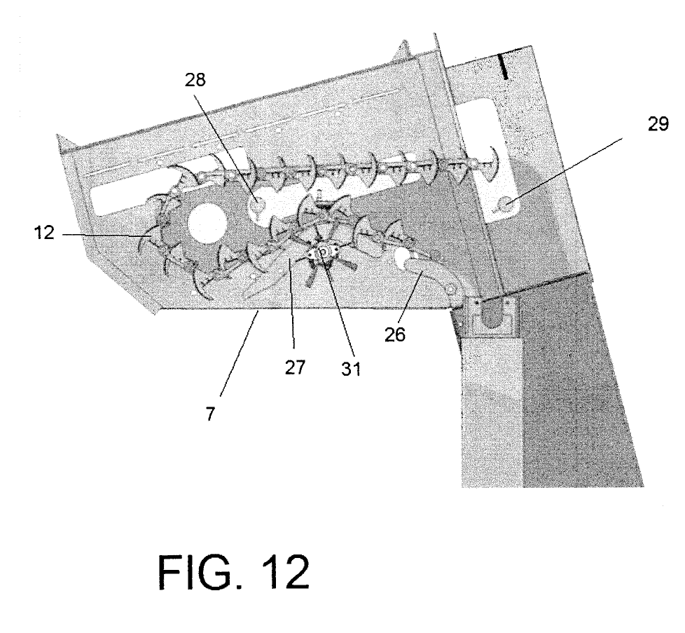

FIGS. 2 and 7 show one of the two cleaning devices 28 is disposed at one of the two release points 25 while the other of the two cleaning devices 29 is disposed at the other of the two release points 24. The cleaning device 29 can disposed at or near the intersection 30 of the substantially horizontal passage 6 and the substantially vertical passage 5. The two cleaning devices 28 and 29 are depicted as being positioned within the closed loop 40 of the endless belt 12 such that the spray of fluid comes from behind the filter plates 11, but any suitable position for the cleaning devices may be used. For example, FIG. 12 shows an alternative placement of the cleaning devices 28 and 29. Also, the cleaning devices 28 and 29 may also be used to clean a brush 31 (described below) and the internal passages of the housing 4 as well as the endless belt 12. In a particularly advantageous embodiment, Actually the cleaning devices are placed at the release point 24 and 25 and substantially parallel to the flange of the filter element that is along the direction where the hook portion 16 runs.

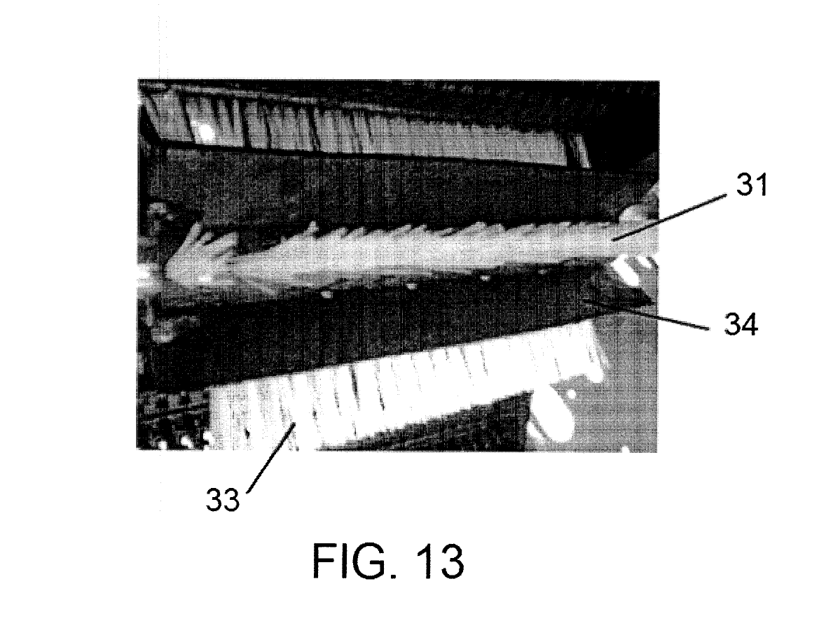

The filter apparatus 1 may further comprise another cleaning device, for example, in the form of a rotatable brush 31 configured to remove the solid material from the filter medium 9. As seen in FIGS. 8 and 13, the brush comprises a central body 32 and a mixture of bristles 33 and wipers 34 disposed and interspersed around the central body 32. The brush 31 may extend along substantially the entire width of the endless belt 12. For example, the brush may extend 60%, 80%, 90%, 95%. 100% or any integer therebetween of the width of the endless belt 12.

The central body can be generally cylindrical, but can also be generally polygonal in cross section. For example, the cross section of the central body may be generally circular, square, hexagonal, octagonal, or any other suitable shape. The central body may be made from rubber or may comprise rubber. Other materials may be used as well, such as fiberglass, plastic (PVC, PE, or the like) or metal (aluminum, steel, stainless steel, or the like).

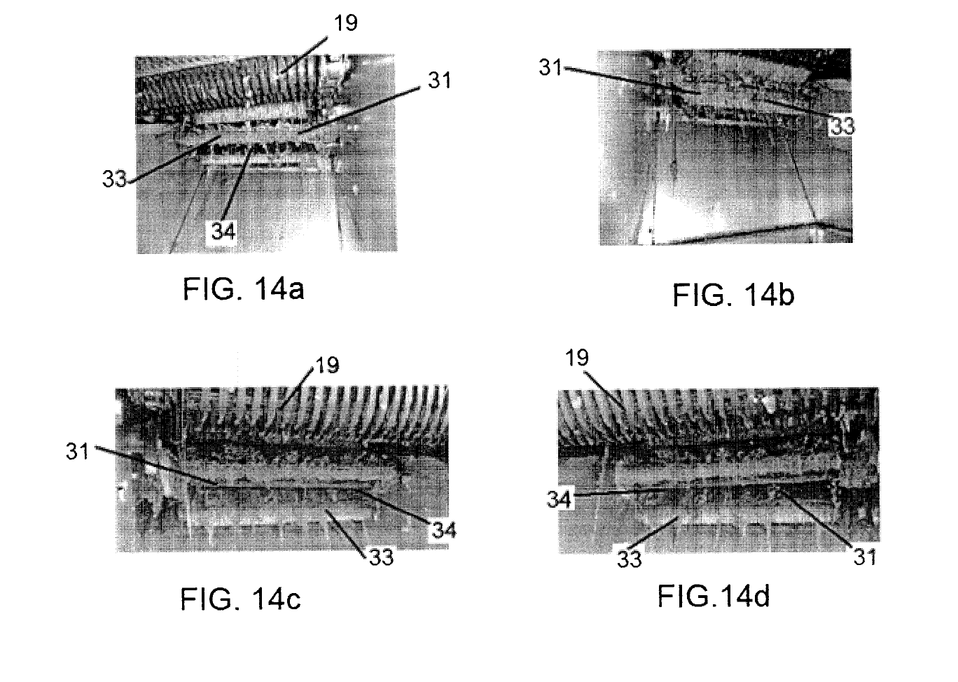

The wipers 34 can function to effectively make the shaft of the brush 31 larger such that stringing solid waste material will not wrap around the larger diameter. FIGS. 14a and 14b show the status of the brush 31 after 1.5 days of use with very little wrapping of stringing material. FIGS. 14c and 14d shows the status of the brush 31 after several weeks in operation with no significant solids wrapped around the brush.

The wipers 34 may be comprised of rubber or some other soft, malleable thermoplastic. For example, the wipers 34 and the central body 32 may be formed integrally a one-continuous piece, either in rubber or in some other suitable material, such as plastic. The wipers may also be separate components that are attached to the central body, for example, by screws, clamps, brackets, welds, staples, or other suitable fastening mechanism.

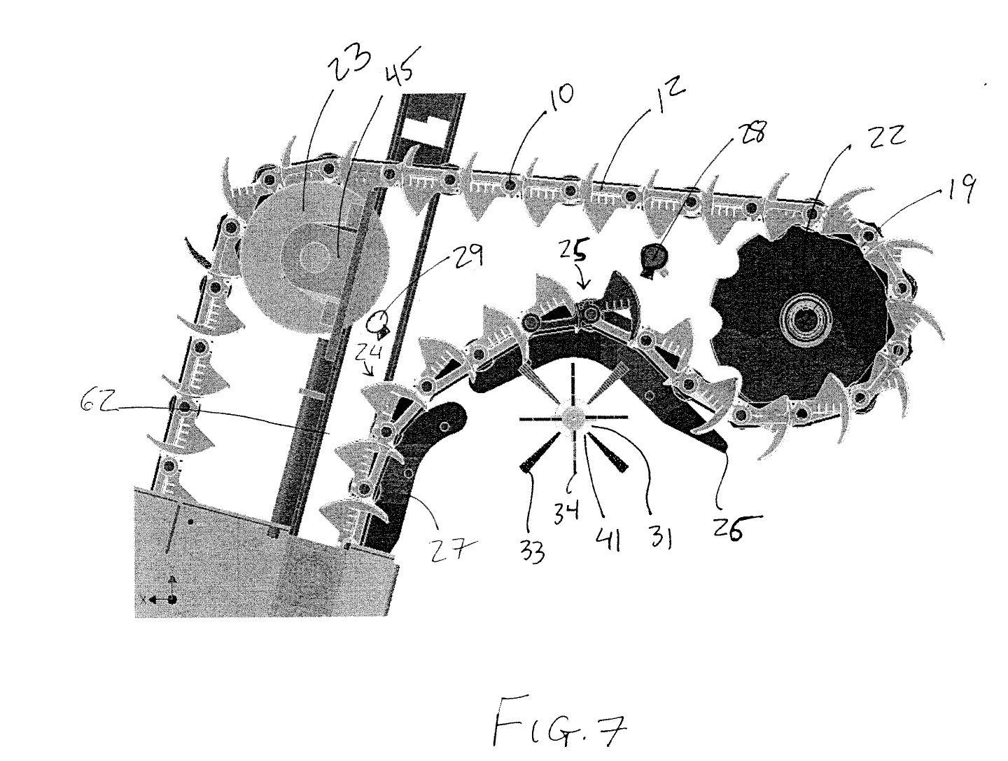

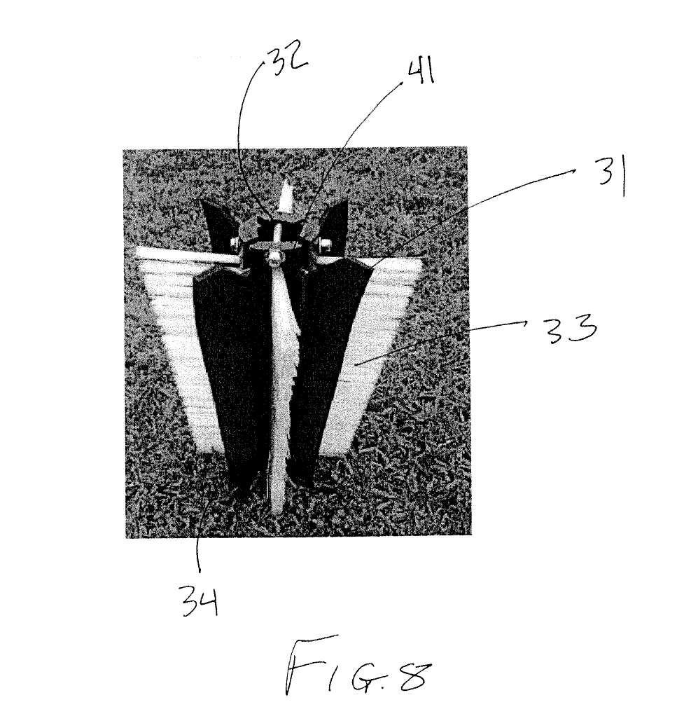

The wipers 34 may be a single protrusion that extends out of the central body 32 and along a substantial portion of the central body 32. For example, the wiper may extend along 50% 60%, 70%, 80%, 90%, 100%, or any integer therebetween of the length of the central body 32. The protrusion may be substantially rectangular shape with a general widening of the rectangle as the wiper approaches its connection point with the central body, as seen in FIG. 9. Alternatively, the wipers may a series of protrusions 34a, 34b, and 34c along the length of the central body 32, as seen in FIG. 10. For example, the wipers may comprise two, three, four, or more substantially rectangular protrusions aligned in a series between adjacent rows of bristles. In another embodiment, the wipers 34 may be a protrusion formed by one, two, three, four, or more pieces of rubber forming a continuous piece.

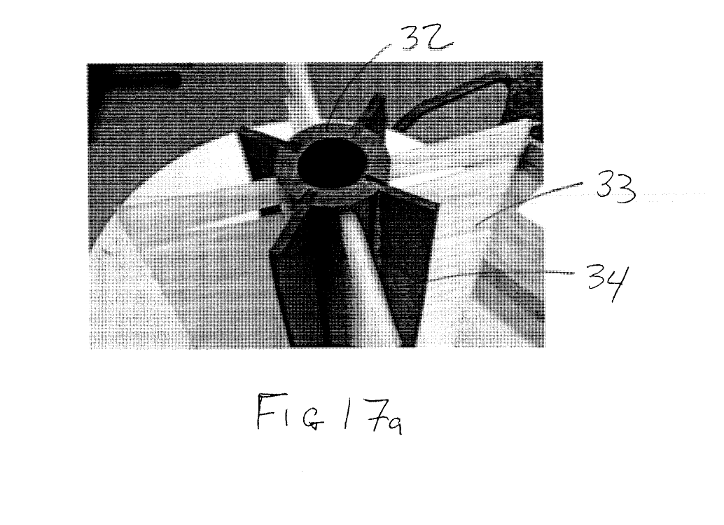

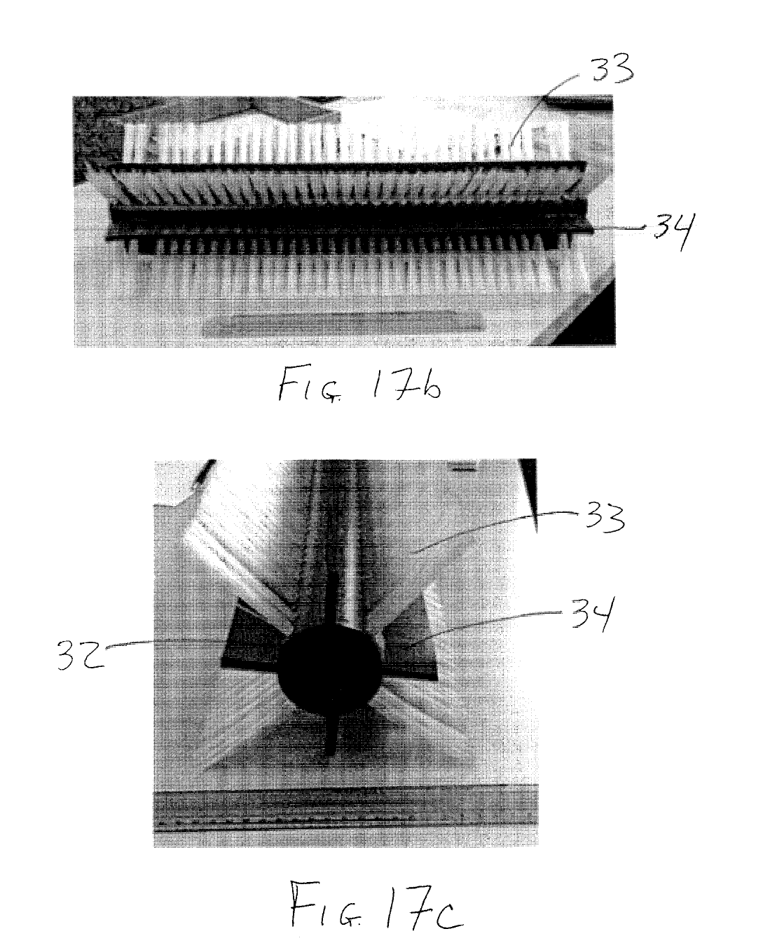

According to another embodiment of the cleaning device, the protrusion of the wiper 34 may be substantially rectangular shape without a general widening of the rectangle as the wiper approaches its connection point with the central body 32, as seen in the embodiment of FIGS. 17a, 17b, and 17c.

The bristles 33 may extend from the central body 32 at a farther distance than a height of the rubber wipers 34. For example, the bristles may be 10%, 20%, 30%, 50% or more or any integer therebetween longer than the height of the rubber wipers 34 as measured from the circumferential surface 41 of the central body 32. The bristles may be any suitable length from the circumferential surface 41 of the central body, such as 1″, 3″, 6″, 12″, 18″, 24″ or more or any integer therebetween. The bristles may be made of any suitable material such as metal (steel, stainless steel, etc.), plastic (PVC, PE, Nylon etc.), composite material (plastic with metal fibers), or the like.

The bristles 33 may be attached to the central body 32 is any conventional manner. For example, the bristles may be inserted into slits in the central body, which are clamped shut. Alternatively, the bristles may be clamped to the central body in any other manner or they may be attached by adhesive, press fit, crimping, stapling or the like.

According to one embodiment of the present invention, the mixture of bristles 33 and wipers 34 may comprise four wipers 34 alternatively spaced with four lines or rows of bristles 33. However, any suitable number of rows of bristles may be used such as 2, 3, 5, 6, or any other suitable number. The same is true for the wipers in which there may be 2, 3, 5, 6, or any other suitable number of wipers. The rows of bristles and wipers may be alternately dispersed about the central body 32 or there may be one wiper for every two rows of bristles, or every three rows of bristles, or every four or more rows of bristles. Alternatively, there may be one row of bristle for every two wipers, or every three wipers, or every four or more wipers.

The rotatable brush 31 may be driven by a drive motor 52 configured to rotate the central body of the brush in an opposite direction from the conveyance of the filter medium 9 around the closed loop (direction A in FIG. 1). Alternatively, the central body of the brush may be rotated in the same opposite direction from the conveyance of the filter medium 9 around the closed loop. The drive motor 52 is configured to rotate the brush 31 at a speed of about 1 to about 100+ rpm, preferably at a speed of about 10 to about 45 rpm. The faster drive speed will be more effective in cleaning the endless belt 12. As seen in FIG. 11, the drive motor 52 may be controlled by the control unit 100. Alternatively, the drive motor 52 may be controlled by a separate control unit. Another alternative embodiment may have the rotatable bush be geared to the drive mechanism 21 for the endless belt 12 such that drive mechanism drives the endless belt and the brush.

As seen in FIG. 7, if a rotatable brush 31 is used, the brush 31 can be located between the two release points 24 and 25. This arrange can provide the following benefit: as the filter plate or element retracts at the release point (such as release point 25), the brush 31 helps to sweep away anything that did not drop off and can clean the interior of the element now that the filter element is retracted. Alternatively, one of the two cleaning devices 29 may be positioned next to one of the two release points 24.

In general, the cleaning device in the form of a rotatable brush 31 according to any of the embodiments discloses herein can be a high speed, hybrid, round bristle brush used to clean wastewater influent screens. It can be designed to remove all the solids contended in the filter elements of the endless belt using a combination of (1) soft bristles to penetrate further and deeper in between the filter elements, and (2) wipers in the form, for example, of rubber paddles, to prevent long rags, hair and threads from wrapping around the core or central body 32 of the brush 31. The brush may rotate opposite to the direction of the endless belt travel or in the same direction , at a speed, for example, of 45 rpm. According to an advantageous embodiment, the brush 31 is a four bristle brush combined with four rubber paddles or wipers, installed in an alternating fashion and separated by 45 degrees. The bristles and paddles are installed on a round, hollow, solid extruded core or central body, with the bristles extending out further from the central body than the rubber paddles or wipers and operated at high speed.

With the brush now described, the advantages that can be obtained by such a brush are now explained. It had been discovered that some filtering apparatuses may not be able to perform efficiently in cleaning the endless belt before re-entering the channel. The results of which are that the equipment often puts solids back in the channel from which the solids were just removed. A rotating brush provides additional removal of solids from the endless belt, but may quickly become ineffective. The cleaning device in the form of the brush is useful in wastewater applications where other influent screen brushes become wrapped up with long, stringy solids very quickly and are very difficult to clean, and therefore ineffective. The brush described herein would not become wrapped up with solids and be easier to clean, remaining more effective longer. Thus, the brush as disclosed herein is beneficial because the wipers or rubber paddles serve a dual purpose: (1) the wipers effectively increase the diameter of the brush shaft, making it very difficult for long stringy solids to wrap around the shaft; and (2) the wipers, turning at high speed, also bat away smaller solids that would otherwise adhere to the brush's central body or core. Furthermore, the brush may be used in any suitable application, such as, for example, the treatment of municipal wastewater, or anywhere that stringy solids need to be removed from continuous moving endless belt screen. The brush can also be incorporated on any existing similar type filtering system.

In addition, other systems may benefit from the brush 31. For example, a filtering apparatus for removing solid material from a fluid in a channel, comprising: a housing that extends from the channel and comprises a passage extending in any suitable direction from the channel (such as, for example, a substantially vertical passage); a filter medium comprising an endless belt of perforated panel(s); and a guide track system configured to guide the endless belt from the channel to the outlet.

A method of inhibiting an unwanted accumulation of waste material captured in an endless belt comprising filtering elements will now be described in the context of the filtering apparatus I described above. The method may comprise turning the endless belt 12 about an axis about which the drive wheel 22 rotates to allow a portion of the solid waste material to separate from the endless belt 12. The separated waste material then exits the housing through the outlet 7, which can be, for example, a disposal chute. The waste material may be collected in a collection device 35, which may further process the waste material and/or convey the material away by a conveying device 36, as seen in FIG. 1.

As for the endless belt 12, the method may further comprise causing rotation of the filter plates or elements 11 at the two or more release points 24 and 25 after the rotation about the axis which the drive wheel 22 rotates to allow dislodgement of a portion of any remaining waste material from the endless belt 12. As described above, the two release points 24 and 25 are formed by arched pathways 27 and 26, respectively, positioned below the endless belt 12.

The method may comprise spraying cleaning fluid on the filter elements 11 at two locations using the cleaning devices 28 and 29. One of the two locations for spraying cleaning fluid is at or near one of the two or more release points 24, 25. Also, the other of the two locations for spraying cleaning fluid is at or near another of the two or more release points 24, 25.

Scrubbing the filter elements 11 using a brush 31 located between the two of the two or more release points 24 and 25 may be performed. One of the two locations for spraying the cleaning fluid may be next to one of the two or more release points 24, 25. The spraying the cleaning fluid may be at a pressure in a range of about 5 to about 100 psi.

Besides those embodiments depicted in the figures and described in the above description, other embodiments of the present invention are also contemplated. For example, any single feature of one embodiment of the present invention may be used in any other embodiment of the present invention. For example, the filtering apparatus and method may comprises any of the following features in any combination:
(1) a housing that extends upward from the channel and comprises a substantially vertical passage, a substantially horizontal passage connected to the vertical passage, and an outlet connected to the substantially horizontal passage;
(2) a filter medium comprising a plurality of transverse rods and a plurality of filter plates rotatably disposed along each of the transverse rods, in which adjacent transverse rods are connected to each other such that the filter plates form an endless belt in a closed loop, in which each of the filter plates comprises a bearing portion configured to remove the solid material from the channel;
(3) a guide track system configured to guide the endless belt from the channel to the outlet;
(4) a drive mechanism configured to convey the filter medium around the closed loop;
(5) the guide track system comprises two or more release points where the bearing portions of the filter plates can rotate about the transverse rods so as to permit dislodgement of the solid material from the filter plates;
(6) the two release points are located in a portion of the closed loop in the substantially horizontal passage;
(7) the two release points are formed by arched pathway(s) positioned below the endless belt in the portion of the closed loop in the substantially horizontal passage;
(8) the arched pathway(s) cause the endless belt to bend concavely inward;
(9) at least one of the two release points is located in the intersection of the substantially horizontal passage and the substantially vertical passage;
(10) the other of the two release points is located at a distance from the intersection of the substantially horizontal passage and the substantially vertical passage;
(11) one, two, or more cleaning devices configured to spray cleaning fluid on the filter medium;
(12) one of the two cleaning devices is disposed at one of the two release points;
(13) the other of the two cleaning devices is disposed at the other of the two release points;
(14) one of the two cleaning devices is disposed at or near an intersection of the substantially horizontal passage and the substantially vertical passage;
(15) a brush configured to remove the solid material from the filter medium, in which the brush is located between the two release points, and one of the two cleaning devices is positioned between or near or adjacent to the brush and one of the two release points;
(16) the two cleaning devices comprise spray bars positioned within the closed loop;
(17) the two cleaning devices are configured to spray the cleaning fluid on the filter medium at a pressure in a range of about 5 to about 100 psi or in a range of about 5 to 10 psi;
(18) a rotatable brush configured to remove the solid material from the filter medium;
(19) the brush comprises a central body and a mixture of bristles and wipers interspersed around the central body;
(20) a drive motor configured to rotate the brush in the same or an opposite direction from the conveyance of the filter medium around the closed loop;
(21) the drive motor is configured to rotate the brush at a speed of about 10 to about 100 rpm or a speed of about 10 to about 45 rpm;
(22) the wipers of the brush are comprised of rubber;
(23) the bristles extend from the central body at a farther distance than a height of the rubber wipers;
(24) the mixture of bristles and wipers comprises four wipers alternatively spaced with four lines of bristles;
(25) a cleaning device for removing solid material from a filter medium comprising: a central body; a plurality of rows of bristles disposed around the central body; and a plurality of wipers interspersed between the rows of the bristles and disposed around the central body;
(26) the wipers and the central body are formed integrally a one-continuous piece from rubber or one or more pieces of rubber forming a continuous piece;
(27) the bristles extend from the central body at a farther distance than a height of the wipers;
(28) the plurality of the rows of the bristles comprises four rows and the plurality of the wipers comprises four wipers alternatively spaced with the four row of the bristles;
(29) a method of inhibiting an unwanted accumulation of waste material captured in an endless belt comprising filtering elements comprising: turning the endless belt about an axis to allow a portion of the waste material to separate from the endless belt; and causing rotation of the filter elements at two or more release points after the rotation about the axis to allow dislodgement of a portion of any remaining waste material from the endless belt;
(30) the two release points are formed by arched pathway(s) positioned below the endless belt;
(31) spraying cleaning fluid on the filter elements at one, two, or more locations;
(32) one of the two locations for spraying cleaning fluid is at or near one of the two or more release points;
(33) the other of the two locations for spraying cleaning fluid is at or near another of the two or more release points;
(34) scrubbing the filter elements using a brush located between the two of the two or more release points;
(35) the spraying the cleaning fluid is at a pressure in a range of about 5 to about 100 psi or in a range of about 5 to about 10 psi;
(36) a housing that extends from a channel and comprises a passage extending in any suitable direction from the channel and an outlet connected to the passage; and
(37) a filter medium comprising an endless belt of perforated panel(s).

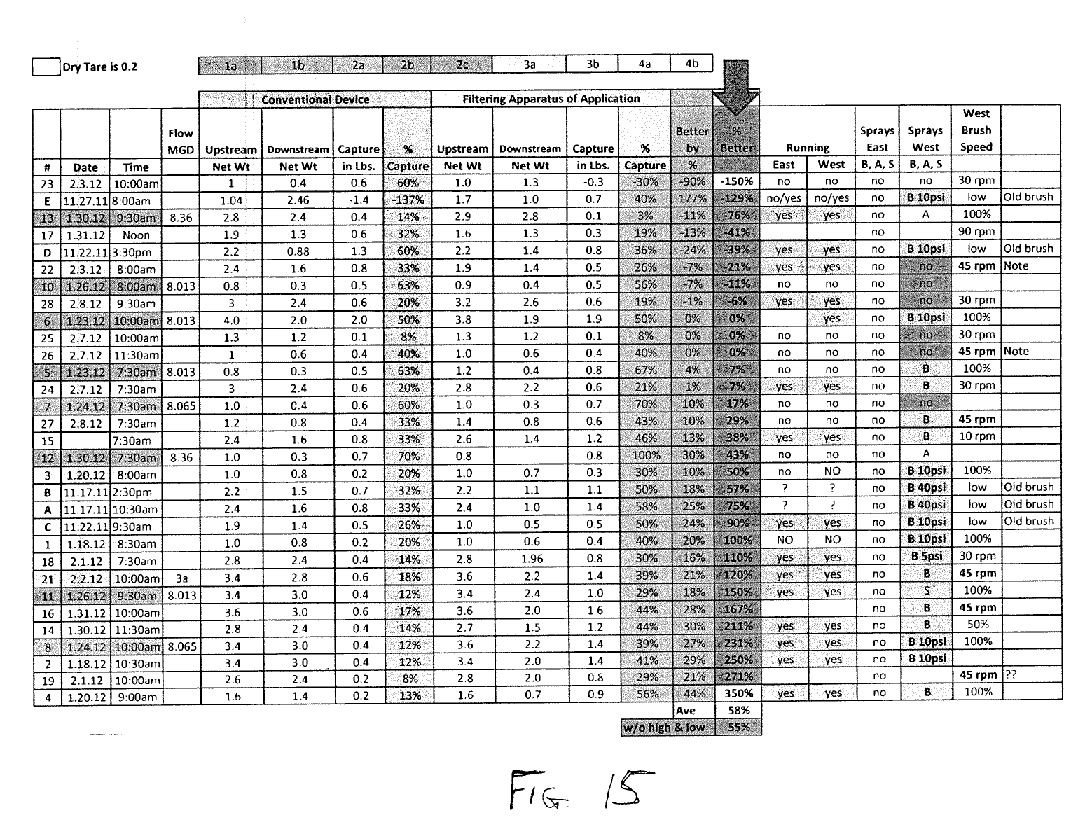

Given the above disclosure, several advantages may be realized. For example, better performance (up to at least 50% improvement) may be achieved by improved capture rate of solids with a cleaner filter medium. FIG. 15 shows a series of runs in which the filtering apparatus 1 shows an overall average improvement of 55% over the performance of the conventional device.

Other advantages may include that a cleaner brush 31 with the wipers 34 would require less maintenance from operators. Also, with the cleaning devices and release points fewer solids would accumulate within the housing and the filter medium. Further, a separate brush drive to increase the speed of the brush may allow for more effective cleaning of the endless belt while providing water savings due to the operation at lower pressure of the spray cleaning devices (such as, for example, 5-10 psi).

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. A filtering apparatus for removing solid material from a fluid in a channel, comprising:
a housing that extends upward from the channel and comprises a substantially vertical passage, a substantially horizontal passage connected to the vertical passage, and an outlet connected to the substantially horizontal passage;
a filter medium comprising a plurality of transverse rods and a plurality of filter plates rotatably disposed along each of the transverse rods, in which adjacent transverse rods are connected to each other such that the filter plates form an endless belt in a closed loop, in which each of the filter plates comprises a bearing portion configured to remove the solid material from the channel;
a guide track system configured to guide the endless belt from the channel to the outlet; and
a drive mechanism configured to convey the filter medium around the closed loop,
in which the guide track system comprises two or more release points where the bearing portions of the filter plates can rotate about the transverse rods so as to permit dislodgement of the solid material from the filter plates, and
in which the two release points are located in a portion of the closed loop in the substantially horizontal passage.

2. The apparatus of claim 1 in which the two release points are formed by arched pathways positioned below the endless belt in the portion of the closed loop in the substantially horizontal passage.

3. The apparatus of claim 2 in which the arched pathways cause the endless belt to bend concavely inward.

4. The apparatus of claim 1 in which at least one of the two release points is located in the intersection of the substantially horizontal passage and the substantially vertical passage.

5. The apparatus of claim 4 in which the other of the two release points is located at a distance from the intersection of the substantially horizontal passage and the substantially vertical passage.

6. The apparatus of claim 1 further comprising two cleaning devices configured to spray cleaning fluid on the filter medium.

7. The apparatus of claim 6 in which one of the two cleaning devices is disposed at one of the two release points.

8. The apparatus of claim 7 in which the other of the two cleaning devices is disposed at the other of the two release points.

9. The apparatus of claim 6 in which one of the two cleaning devices is disposed at or near an intersection of the substantially horizontal passage and the substantially vertical passage.

10. The apparatus of claim 6 further comprising a brush configured to remove the solid material from the filter medium, in which the brush is located between the two release points.

11. The apparatus of claim 6 in which the two cleaning devices comprise spray bars positioned within the closed loop.

12. The apparatus of claim 6 in which the two cleaning devices are configured to spray the cleaning fluid on the filter medium at a pressure in a range of about 5 to about 10 psi.

13. A filtering apparatus for removing solid material from a fluid in a channel, comprising:
a housing that extends from the channel and comprises a passage, and an outlet connected to the passage;
a filter medium comprising an endless belt in a closed loop configured to remove the solid material from the channel;
a guide track system configured to guide the endless belt from the channel to the outlet;
a drive mechanism configured convey the filter medium around the closed loop; and
a rotatable brush configured to remove the solid material from the filter medium, in which the brush comprises a central body and a mixture of bristles and wipers interspersed around the central body.

14. The apparatus of claim 13, further comprising a drive motor configured to rotate the brush in an opposite direction from the conveyance of the filter medium around the closed loop.

15. The apparatus of claim 14 in which the drive motor is configured to rotate the brush at a speed of about 10 to about 45 rpm.

16. The apparatus of claim 13 in which the wipers of the brush are comprised of rubber.

17. The apparatus of claim 13 in which the bristles extend from the central body at a farther distance than a height of the rubber wipers.

18. The apparatus of claim 13 in which the mixture of bristles and wipers comprises four wipers alternatively spaced with four lines of bristles.

19. A cleaning device for removing solid material from a filter medium comprising:
a central body;
a plurality of rows of bristles disposed around the central body; and
a plurality of wipers interspersed between the rows of the bristles and disposed around the central body.

20. The cleaning device of claim 19, further comprising a drive motor configured to rotate the central body at a speed of about 10 to about 45 rpm.

21. The cleaning device of claim 19 in which the wipers and the central body are formed integrally a one-continuous piece from rubber.

22. The cleaning device of claim 19 in which the bristles extend from the central body at a farther distance than a height of the wipers.

23. The cleaning device of claim 19 in which the plurality of the rows of the bristles comprises four rows and the plurality of the wipers comprises four wipers alternatively spaced with the four rows of the bristles.

24. A method of inhibiting an unwanted accumulation of waste material captured in an endless belt comprising filtering elements, comprising:
turning the endless belt about an axis to allow a portion of the waste material to separate from the endless belt; and
causing rotation of the filter elements at two or more release points after the rotation about the axis to allow dislodgement of a portion of any remaining waste material from the endless belt.

25. The method of claim 24, in which the two release points are formed by arched pathways positioned below the endless belt.

26. The method of claim 23, further comprising spraying cleaning fluid on the filter elements at two locations.

27. The method of claim 26, in which one of the two locations for spraying cleaning fluid is at or near one of the two or more release points.

28. The method of claim 27, in which the other of the two locations for spraying cleaning fluid is at or near another of the two or more release points.

29. The method of claim 26, further comprising scrubbing the filter elements using a brush located between the two of the two or more release points.

30. The method of claim 26 in which the spraying the cleaning fluid is at a pressure in a range of about 5 to about 10 psi.
